(19) United States
(12) Patent Application Publication
(10) Pub. No.: US 2012/0245954 A1
(43) Pub. Date: Sep. 27, 2012

(54) Medical Record Collection System

(75) Inventors: Michael Klotz, Pacific Palisades, CA (US); Ronald H. Makita, Sunland, CA (US)

(73) Assignee: MRCS Holdings LLC

(21) Appl. No.: 13/053,502

(22) Filed: Mar. 22, 2011

(51) Int. Cl. G06Q 50/00; G06Q 10/00

(52) U.S. Cl. 705/3

(57) ABSTRACT

A medical collections system to provide an efficient, scalable, and accurate process for collecting, analyzing, and delivering medical records or analysis of medical records to a client, the system comprising a computer architecture that allows configuring projects to be performed and delivered according to the client's predetermined standards, loading data in a standardized and organized way to map provider information, scheduling requests, retrieving records, and utilizing quality checks to check for quality of the records retrieved, analyzing the records, maintaining accuracy of the analyzed record through an overread process, and delivering high quality results that can be reviewed by and delivered to clients according to the client's specification.

### BACKGROUND OF THE INVENTION

1. Technical Field

This invention relates to an internet based system for locating, collecting, and analyzing medical records and delivering these records and the analysis results of the medical records to clients and other organizations.

2. Background Art

Each year hundreds of health insurance companies, accreditation and government agencies as well as pharmaceutical companies, medical services companies, and universities need to audit providers and medical records for compliance, billing, research, and quality, which amounts to millions of healthcare records that need to be securely accessed, reviewed, analyzed and reported on. These studies and audits are key components of ongoing healthcare quality and research.

The current ways of accomplishing these critical needs are very cost-intensive and ineffective, having an adverse impact on both top and bottom line. The processes of many of the companies providing these services have remained unchanged for many years and have not kept up with the changing technologies in the healthcare industry. They often require constant training and re-training of staff that changes from project to project, and require qualified record reviewers to be in close vicinity of the providers and facilities being audited. Systems for most companies providing these services do not have provisions for providing quality and completeness checks at each step of the process, which compromises results and slows the process.

Thus, there is a need for a medical records collection and analysis system that has a process-oriented, end-to-end configurable workflow with detailed status tracking and audit trails and a high level of automation.

### BRIEF SUMMARY OF INVENTION

The present invention is directed to a medical records collection system that is a fully integrated and highly automated process solution for the collection and delivery of results of an analysis of a desired paper medical record. It implements a flexible workflow and a number of optimized functionality aiding the performance of steps in the process. The unique implementation allows for specialized job roles, using highly qualified personnel only where their expertise is truly needed, leaving other tasks to non-medical personnel or to automation.

It utilizes a web-based, secured application with role based security, allowing provisioning users for certain activities, and for clients to access a client portal through a client application, which provides reporting, review, feedback and download features. The system implements a superior process and specialized tools which address the needs for volume, speed, quality and visibility for clients' review.

The system implements years of best practices and a highly optimized process that breaks down inefficiently performed tasks into more granular steps with defined main process flows and numerous exceptions and alternative paths. This makes the process very repeatable, scalable and auditable. Manual steps, to the extent required, are aided and made very efficient through the support of functionality in the system. This is especially important as quality and auditability of the quality of the analysis has not been achieved in a consistent fashion in the industry, especially at high volumes.

The system, due to the process approach taken, has comprehensive meta-data, spanning the life of a process instance, which enables detailed status reporting, intelligent routing, elimination of many common errors, speed, and efficiency. The result is superior quality, the ability to audit the quality, and a significant cost-advantage due to automation.

The system eliminates errors due to the ability to have a meta-data driven process, allowing the system to ‘lock down’ many variables and causes for errors or omissions in the process, for example, the association of medical records with the appropriate patient and provider information.

The system also implements secondary pursuits of missing records, which aids personnel in the scheduling function to locate medical records at locations not previously identified.

### BRIEF DESCRIPTION OF THE DRAWINGS

FIG. 1 is a flow diagram an embodiment of the overall process of the medical record collection system;

FIGS. 2A-2C is a flow diagram of another embodiment of the overall process of the medical record collection system;

FIG. 3 is a screen shot of the project configuration window;

FIG. 4 is a screen shot of a window displaying project measures;

FIG. 5 is a screen shot of a window displaying a provider site list;

FIG. 6 is a screen shot of a window displaying detailed information of a provider;

FIG. 7 is a screen shot of a window displaying a geo-coded map;

FIG. 8 shows the capture screen used by Field Technicians when scanning medical records;

FIG. 9 shows an example of a chart cover sheet with a checklist;

FIGS. 10A and 10B are screen shots of a window displaying a triage detail;

FIG. 11 is a flow diagram of the overread process;

FIG. 12 is a partial screen shot of a window displaying the overread screen;

FIGS. 13A-13E are screen shots of features from the client portal;

FIG. 14 is a server topology diagram of the system architecture;

FIG. 15 is a conceptual diagram of system components of an embodiment of the system architecture;

FIG. 16 is a flow diagram of another embodiment of the system architecture;

FIGS. 17A-17B show a flow diagram of the process of retrieving records; and

FIGS. 18A-18C show a system flow diagram for chart processing.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for operating the invention in connection with the illustrated embodiments. However, it is to be understood that the same or equivalent functions and sequences may be accomplished by different embodiments that are also intended to be encompassed within the spirit and scope of the invention.

The medical records collection system provides an efficient and accurate system for collecting, analyzing, and delivering medical records or analysis of medical records to a client or client system. The system utilizes the Internet to allow employees or clients to configure their own projects to be performed and delivered according to the client's predetermined standards, or project requirements. It improves efficiency by standardizing, mapping, and geo-coding provider information, provides organization by utilizing a unique scheduling system for requesting and retrieving records via means such as fax, mail, portal, or electronic medical record. It economizes record retrieval by providing the option of using field technicians, and improves accuracy utilizing the triage system to check for quality of the records retrieved. It provides tools for analysis by qualified staff members (typically clinicians) through abstraction of the records, maintains accuracy of the abstraction through an overread process, and delivers highly accurate results that can be reviewed by and delivered to clients according to the client's specification.

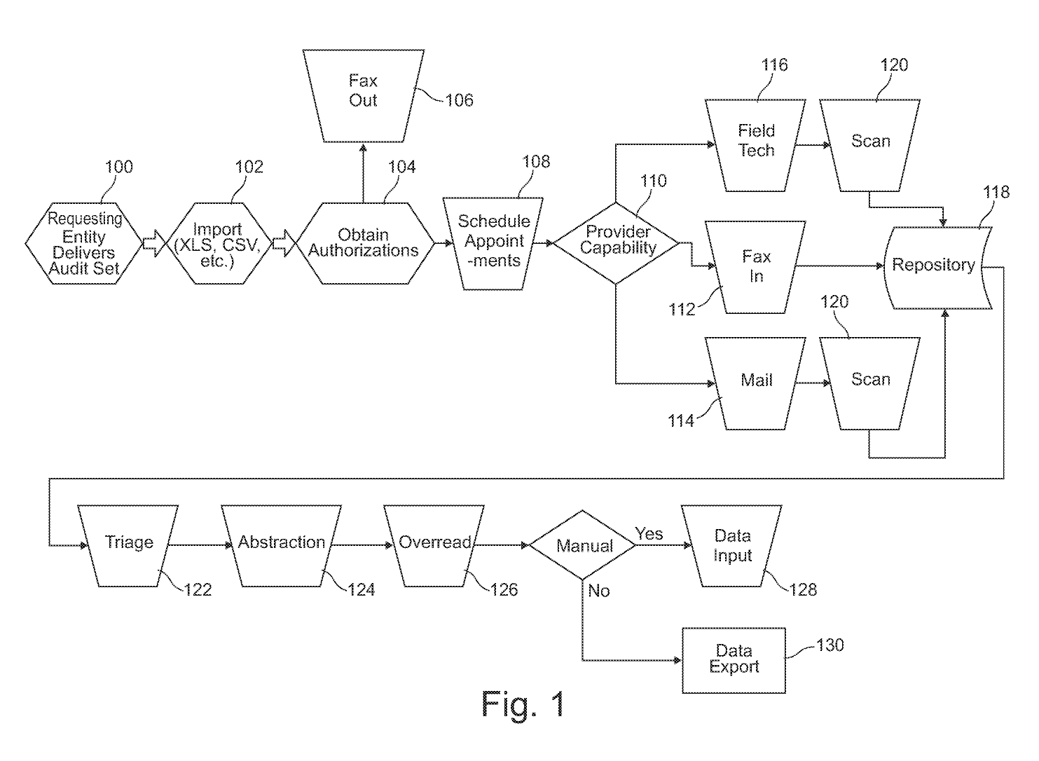

As shown in FIG. 1, in one embodiment, a request is made, for example, when a client or external system delivers an audit set 100. This is imported 102 into the system. Once imported, the proper authorization to collect the records is obtained 104. The authorization request is usually in the form of an automatically generated fax 106. Once the authorization is obtained an appointment is scheduled 108 with the provider to obtain the proper records. A determination is made as to the provider's capabilities or preferences for delivering the records 110. For example, the provider may fax 112, mail 114, or upload the records through a client portal. Alternatively, the provider may simply make the records available for a field technician to scan on-site 116. Once the record is retrieved, it is securely deposited into the repository 118. In some embodiments, the record may be scanned 120 and deposited into the central records repository 118 at the data center.

Once in the repository, the record undergoes a triage step 122 in which the record is assessed for legibility and completeness. The record is then sent to an abstractor 124 for abstraction (i.e. analysis). For quality control of the analysis work, the abstraction results may be selectively overread 126. The new data may be inputted 128 into the system prior to being exported to the client 130.

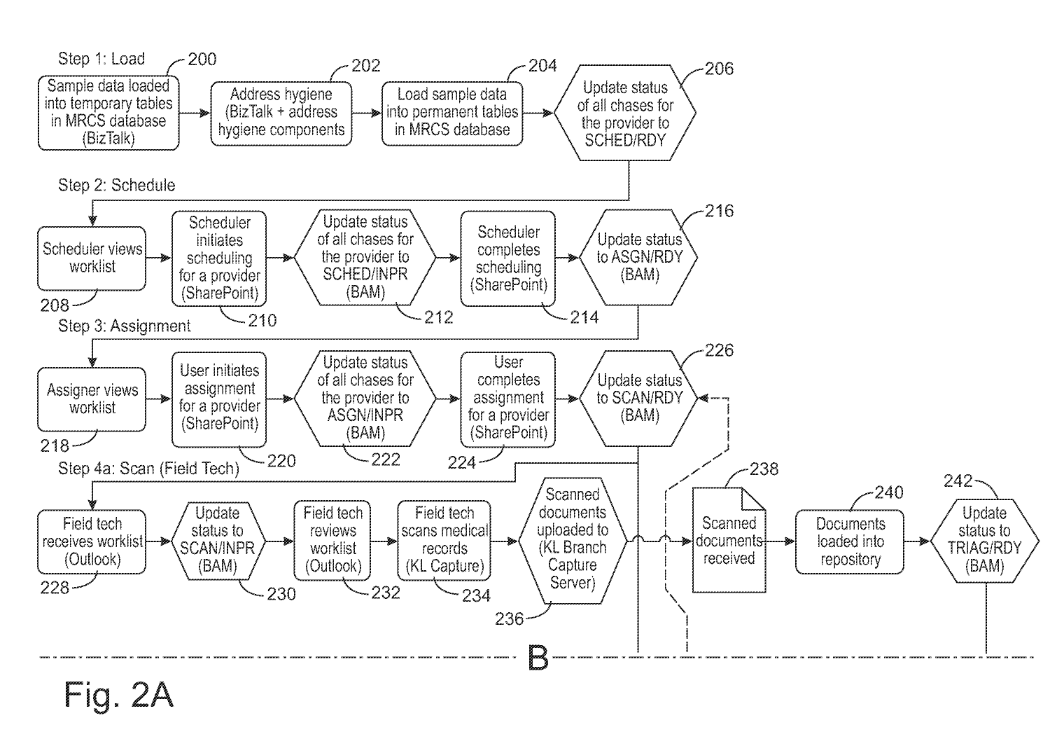

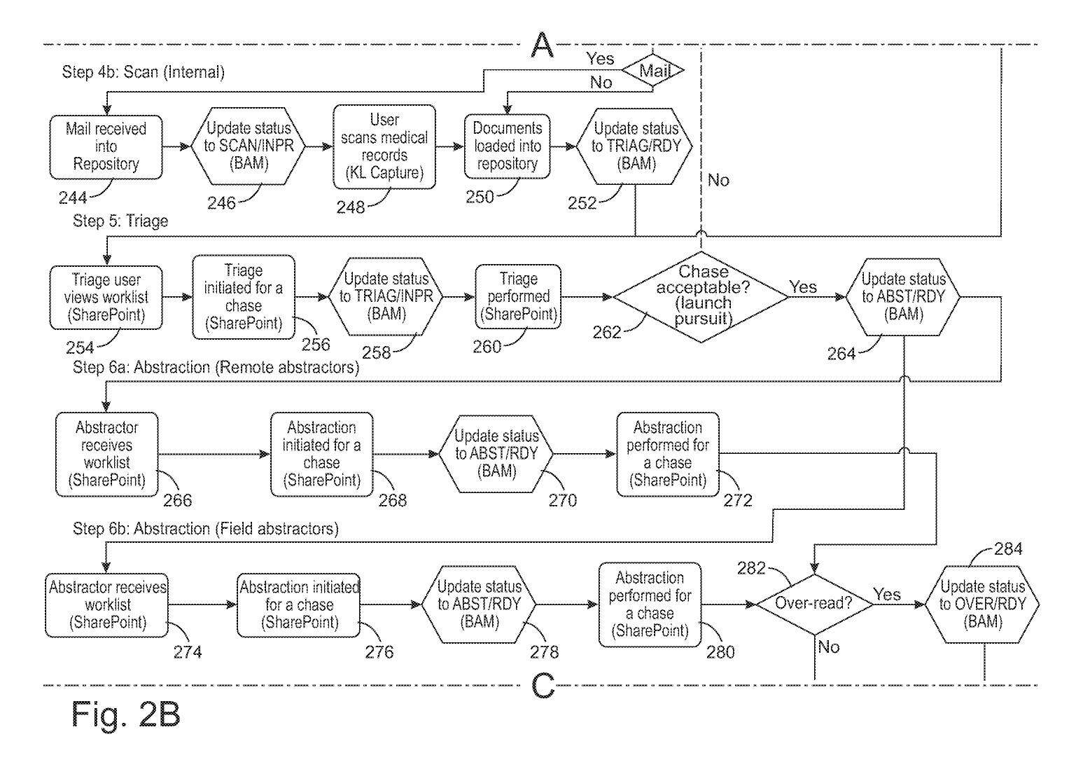

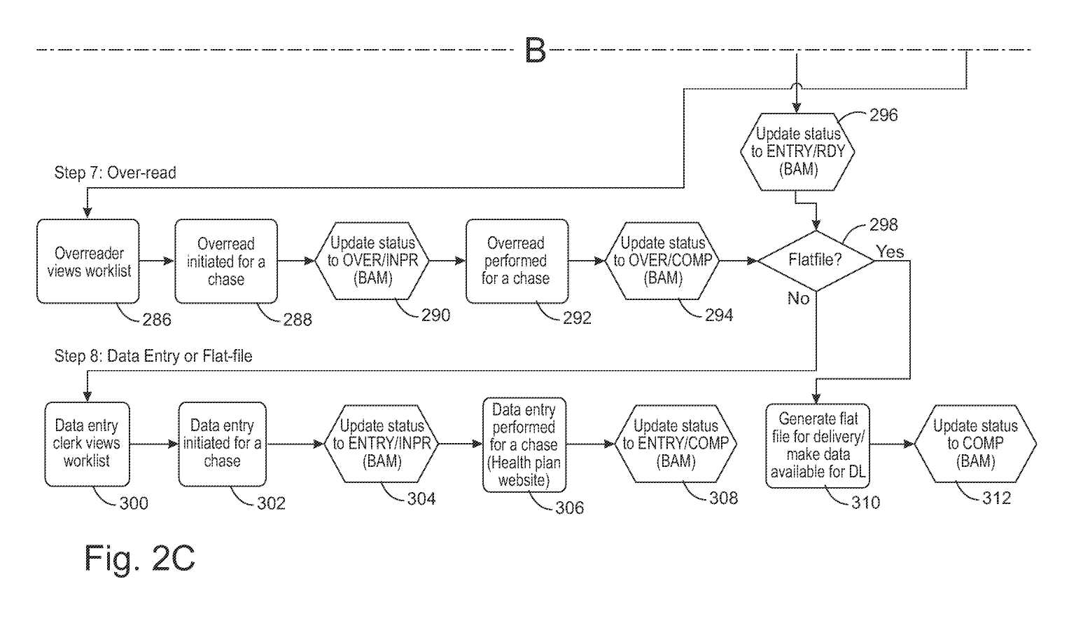

FIGS. 2A-2C show a flow diagram of examples of specific steps involved in various embodiments of the present invention.

Project Configuration

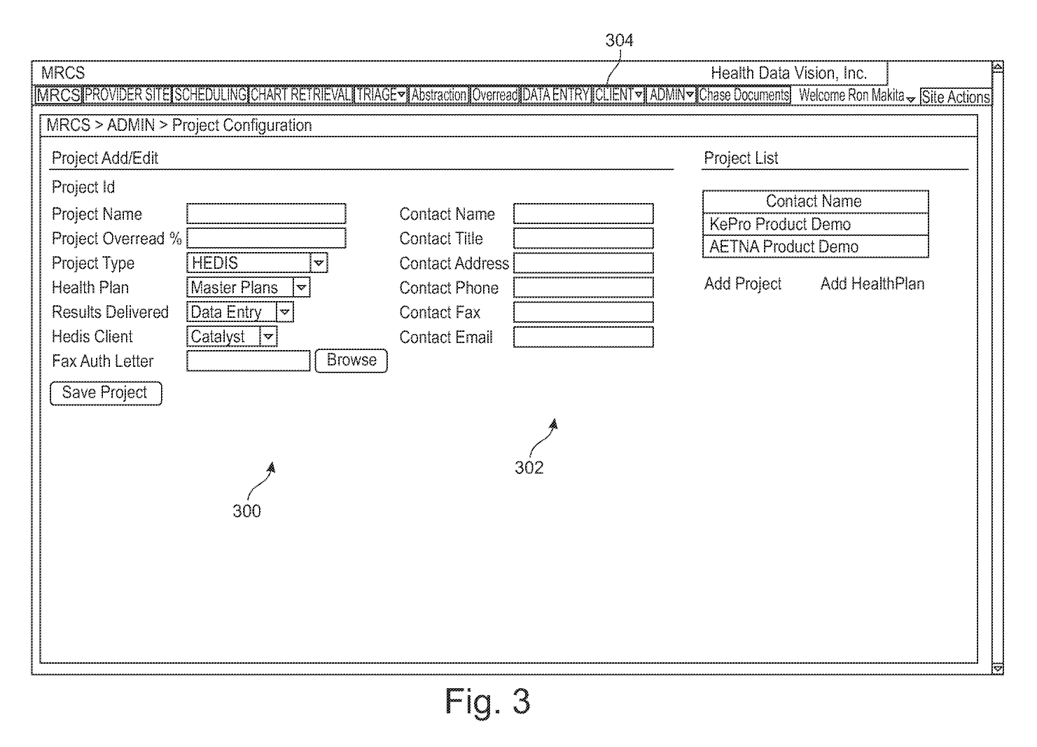

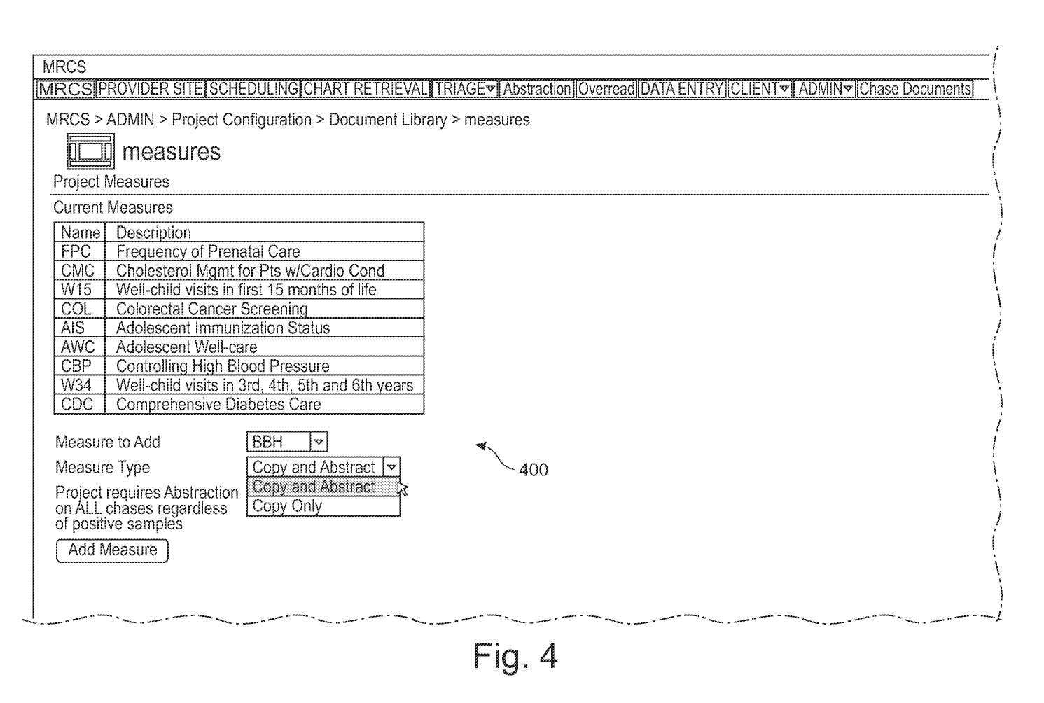

Clients and projects are set up and configurable in the system so that a client can choose the level of service for a particular project and select various processing preferences, as shown in FIGS. 3 and 4. The project configuration window provides appropriate fields 300 to configure the project as well as contact information 302. In other words, the client can choose which steps in the system the client wants the system to execute and the level of care or scrutiny with which the steps are carried out. For example, a particular client may have internal staff perform some of the process steps themselves, such as the abstraction or overread processes. The system may be configured to exclude the abstraction or overread process for this particular client. Alternatively, rather than excluding a step all together, the system may be configured, for example, so that the level of overread or the overread percentage (QA sample rate) is decreased or increased to affect the level of the quality checks for a particular project.

To configure a project, a new record is set up containing the client's identifying information, such as name, address, contact information, and the like. Additional information, such as the client's affiliation with other entities or organizations may be inputted into a client setup screen.

A client application is provided through which the client can access all pertinent project information. A client can communicate with the system using a client portal 304 that can be accessed via a web browser or different computing devices, such as a computer, laptop, netbook, phone, personal digital assistant, smart phone, BlackBerry, iPhone, tablets, and other like electronic devices that can send and receive communications through the internet, radiowaves, and the like. The client's preferences may be configured so that the system may be instructed with which actions to take or services to provide, with what level of quality to execute those actions or provide those services, and how and what to deliver to the client as the final product.

For example, as shown in FIG. 4, if the client is able to self-abstract or self-overread (i.e. perform the abstraction step or the overread step internally), configuration options 400 are available so that the project may be configured as “copy only” where health records or medical records are collected and delivered only, leaving the abstraction and overread steps for the client to perform outside of the system. Alternatively, the client's project may be configured for “Copy and Abstract” if the client wants the system to review the records and conduct an analysis.

If the client selects the “Copy and Abstract” configuration, the client can further select the quality of overread. A percentage between 0% and 100% may be entered, depending on the client's requirements. This percentage becomes the percentage of each abstractor's records that get overread for quality by senior abstractors.

The delivery options of the final product can also be configured. Options are presented to the client for delivering either a flat file of the results or data entry to client's application. The flat file delivery may be an electronic copy of any results obtained analyzing charts obtained from the providers and/or the results of the abstraction of those charts. Data entry allows a staff member to view collected data on a display screen and input the requested information into an external system for further processing. The client can then review the inputted information by accessing the client portal 304, even from a remote location using any electronic device that is capable of transmitting and/or receiving communications through a landline or wirelessly. For example, the client can review the inputted information by accessing the client portal 304 securely through a Web browser through the Internet.

An authorization letter from the client may also be attached to the project. When faxing out medical record requests to providers for the project, this letter is automatically faxed with the request.

The project can also be configured for a specific measure. A measure is the medical condition or any other information to be queried by the client for a specific purpose, such as wellness, lifestyle, health, clinical, medical, pharmaceutical information, and the like. For example, the measure of a particular project may be a specific patient's blood pressure, cholesterol level, blood-glucose level, lab results, X-rays, scans, and the like. It may even be more comprehensive such as the medical condition of a specific patient, such as diabetes, cancer, or atherosclerosis.

Once the project has been configured, the system can dispatch its staff members to perform the necessary function, such as collecting the proper records, analyzing the records, and delivering the analysis to the client.

Data Load

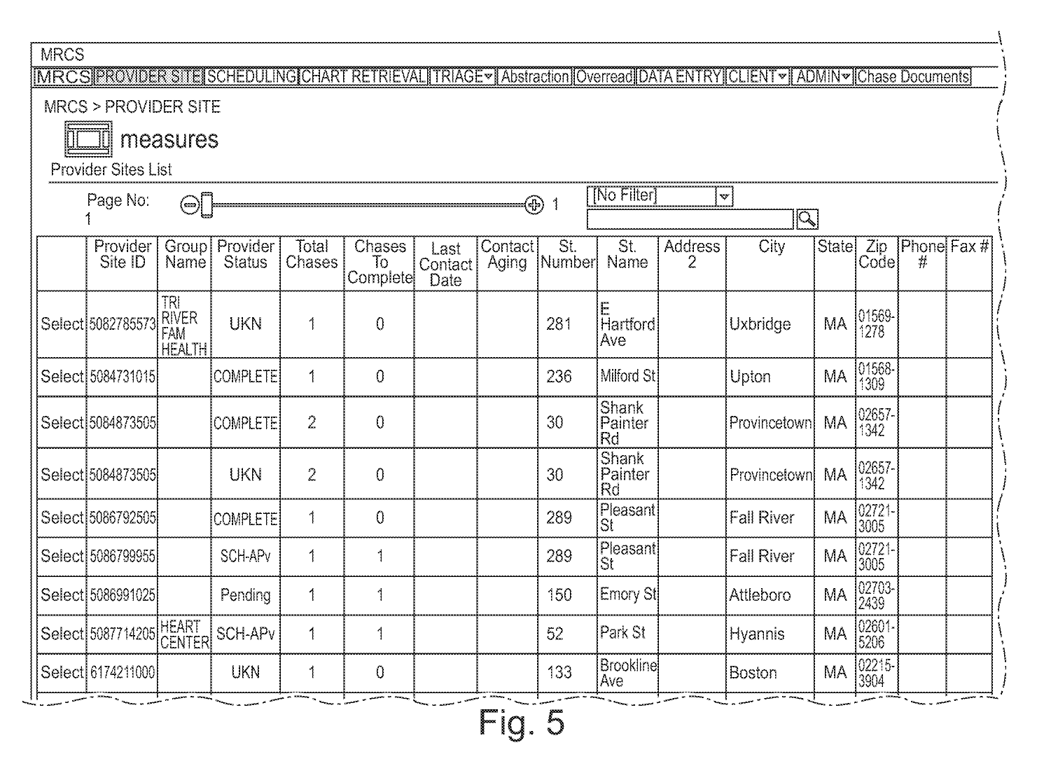

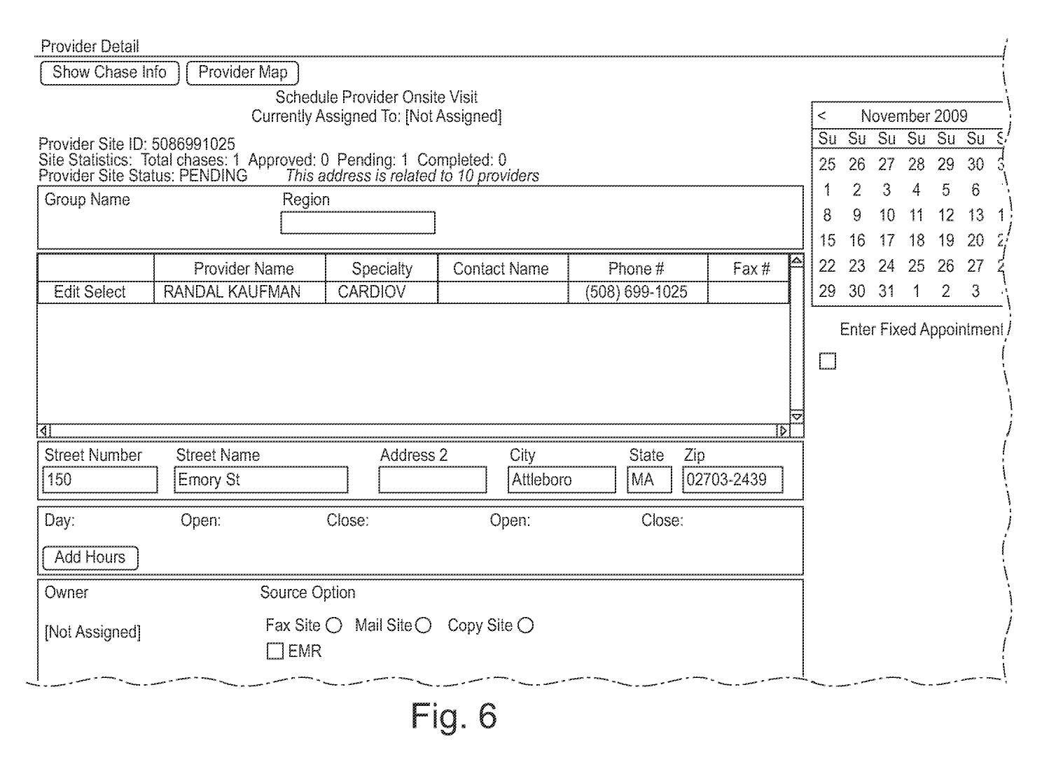

As shown in more detail in FIGS. 2A-2C, to facilitate the efficient dispatching of team members to collect the required information from the providers, for example, providers' addresses are collected and inputted into the system 200. This information may be checked, standardized, and organized. This process is referred to as address hygiene or address scrubbing 202, which may include geo-coding. For example, names and addresses may be edited to comply with the established formats for uniformity. Once the information is scrubbed, it may be placed into a permanent database 204, and the status of request or chase for the provider is updated as being ready for scheduling (SCHED/RDY) 206. Member and provider information provided by the client is loaded into the system which organizes and displays the provider information in a sortable table as shown in FIG. 5. The information may be sorted according to a variety of headers. Any entry can be clicked on to retrieve information on a provider as shown in FIG. 6.

Often times clients provide the provider's address 700. The information provided by the clients may be either in inconsistent formats, or incorrect or non-existent addresses. This causes delays in the scheduling process and possibly results in incomplete record collection.

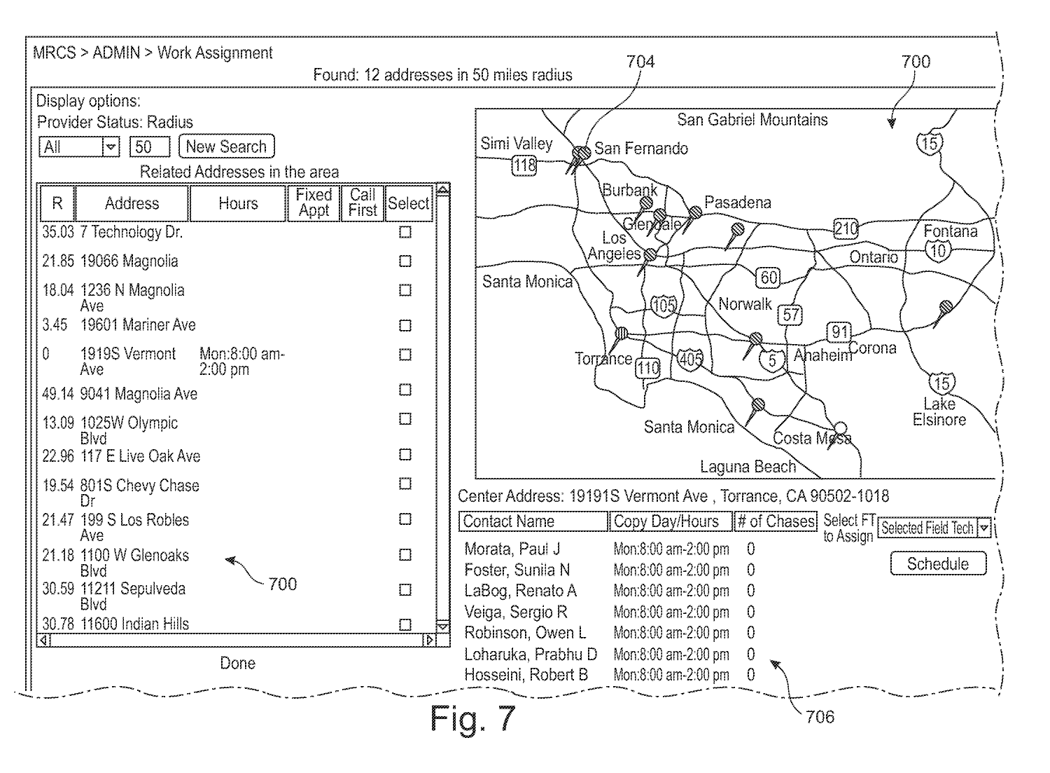

Therefore, once the information is collected and inputted into the system, the information may be verified, standardized, and geo-coded which makes the downstream steps of the process much more efficient. A staff member may look up the address 700 or call the provider to ensure the address 700 is correct and up to date. The staff member may edit the address 700 so that it complies with the specific format utilized by the system. In addition, to geo-code the provider's location, the addresses are mapped on an electronic map 702 with color coding 704 indicating the status of the address for display on a monitor, screen, or other type of display device as shown in FIG. 7. The color coding 704 provides additional information to help the system run efficiently. For example, the color coding 704 may indicate that the address has been verified or still requires verification or the color coding may indicate if a field technician has been assigned to the address. The contact and copying information 706 may also be provided.

This step assures that provider locations are correctly combined so the provider receives a single consolidated request rather than multiple requests. Exception addresses that cannot be verified or that are incorrect will be researched by a scheduler to correct. If the scheduler is unable to resolve the problem, addresses may be returned to the client for correction or verification.

By performing the address hygiene step certain inefficiencies may be avoided such as dealing with redundant requests to the provider or sending requests to wrong providers outside of the system. Exception addresses are often times not identified until late in the project, therefore, this process allows for early detection and correction.

Once the provider information is edited and standardized, schedulers can efficiently schedule the collection and retrieval of the records required for the completion of the requested project.

Scheduling

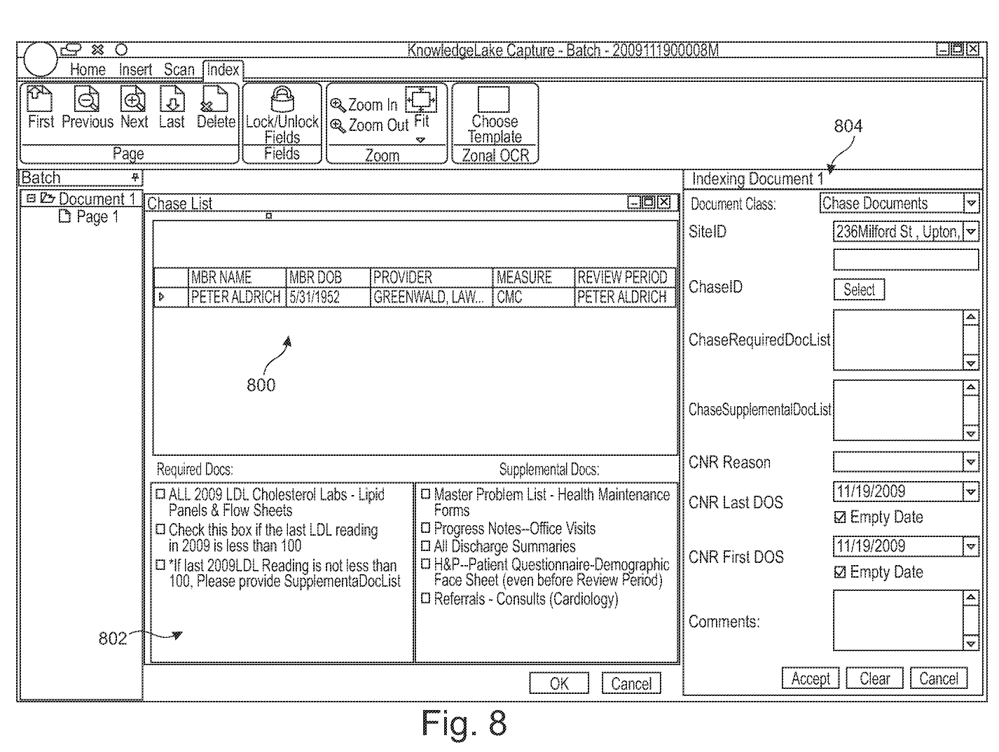

Schedulers manage the submission of the request for a record, referred to as a chase, and the retrieval of the requested document. FIG. 8 shows a sample of a chase document with the provider information 800, a section for the scheduler to indicate the desired documents 802, and section for indexing 804. To perform efficient submission and retrieval of the desired document, the scheduler contacts the provider, submits the request, monitors the status of the request, and coordinates the retrieval of the records.

Schedulers may be assigned specific providers to contact and to submit record requests. Schedulers may be assigned to specific providers based on the provider's site or location, such as the provider's state, city, area code, or zip code. This geographical assignment also facilitates efficient dispatch of field technicians. Other characteristics may be used to assign providers to schedulers, such as affiliation of the provider, specializations of the provider, and the like.

The scheduler's station is equipped with a computing device to view his or her worklist 208, such as a computer executing a specific program application to contact and monitor the providers. Since specific schedulers are responsible for specific providers or providers located at a specific site or area, when a scheduler signs in or logs in to the systems, the scheduler's default screen will be to see only a summary of their assigned providers. For example, the summary may display the provider's status and last contact date/contact aging.

The provider detail comprises a list all providers at the assigned or designated site with a record request, phone, fax, and address information. The scheduler can also view record request (chase) details and can view the providers' location on a map. Provider geo-coding (color coded map) also allows schedulers visibility of other nearby facilities on the map, which allows them to efficiently work on sites that are close to each other.

The scheduler may also be provided the option of viewing all providers in the system or searching for specific providers or groups utilizing multiple search and filtering options, such as keyword searches, alphabetical listing by name of provider, listing based on name of patient being queried, specializations, and the like.

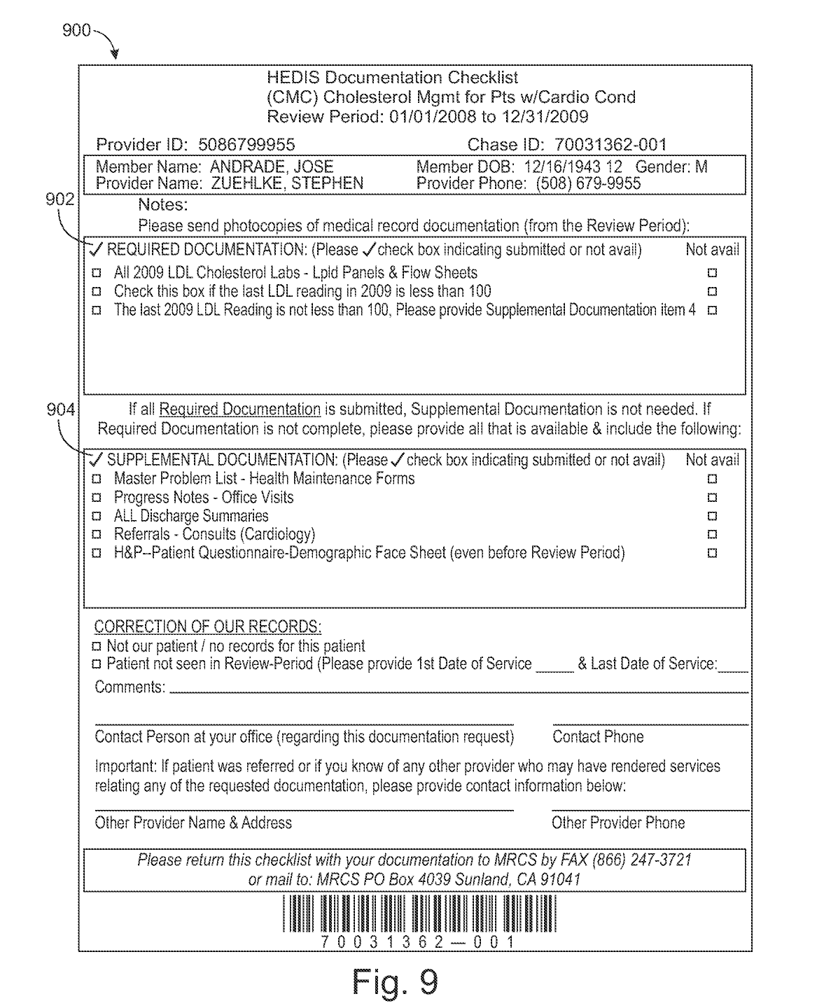

The scheduler initiates the scheduling process 210 and updates the status of chases for the provider as being ready in progress (SCHED/INPR) 212. The scheduler has options to configure the record request package by selecting a retrieval type (fax, mail, copy, e-mail, Internet) which will automatically choose the proper documents to send to the provider to effectuate the retrieval by the selected mode of delivery. Individual record requests that include specific documentation required for review may be sent by any mode of communication, such as fax, mail, e-mail, and/or Internet. These request documents 900 include checklists (as shown in FIG. 9) for retrieving complete records for each member or patient. Schedulers have visibility of the date/time for each request and all contacts with the provider to monitor, update, or change any request. Schedulers also have visibility of very detailed status codes by provider location and individual chase, depending on what stage of the process the project is currently in.

In one example, schedulers contact providers and fax out requests for medical records. The fax includes a customizable fax cover sheet explaining the request, its purposes, etc. (a statement that authorizes system to collect records on behalf of the client, and appropriate language in compliance with the Health Insurance Portability and Accountability Act (HIPAA), a consolidated listing of the members being requested, and individual record requests for each member. The individual record requests 900 contain measure-specific checklists 902, 904 of documents required to fulfill the measure.

For documents that are expected to be scanned by field technicians, the scheduler has the option of excluding the individual member requests. Each time a request is sent to a provider, a record of the request is created in the contact history and stored as a comment with the date, time and requested members.

Schedulers arrange for record retrieval by requesting return of the records via fax, mail, email, and/or Internet, or to schedule onsite visits by a field technician who scans the records. Once the retrieval method is determined, schedulers identify the proper contact person at the provider that is responsible for the release of the records. A contact history of each conversation and contact with the provider is recorded.

There may be cases where a provider alerts a scheduler that the information sought for a member does not exist. It may be that the member is not a patient of the provider, the member may not have been seen in the time frame of the measure, or a number of other reasons. In those cases, the scheduler may create a Certificate of No Record (CNR) for that member and categorize the CNR by reason code, which indicates the reason why the information sought for that member did not exist in the provider's files. A CNR can be viewed by the client for verification. The provider may also provide the scheduler with information that a member's record may be at another location, or that there may be multiple records for the member. Options are available to easily copy or reassign a chase to another provider (or the provider's second location).

Once the scheduler completes the scheduling 214, the status of the chase is updated as being ready for assignment (ASGN/RDY) 216. When a site is approved for the field technician scanning, the scheduler enters the date and time available for scanning or sets up an appointment for scanning by the field technician.

Assignment

All approved sites become available to assign to field technicians if determined that they will not or cannot fax, mail, or upload the requested information. An administrator or assigner views the worklist for assignment 218 and initiates an assignment 220. For example, the administrator can view addresses, days and hours for copy, and the number of records scheduled for copy. The administrator may also view a map of the location along with other nearby providers. The chase status is updated to reflect that the chase is in the process of being assigned (ASGN/INPR) 222. Once assigned, it may be sent to the field technician 228 securely via the Internet, to a dedicated field technician equipment. As one example, the task may be submitted via Outlook. Once the assignment is complete 224 the chase status may be updated as being ready for scanning (SCAN/RDY) 226.

The chase status is updated to reflect that the records for the chase or in the process of being scanned 230. The task may include the address, site information, contact information at the site, appointment time or available scanning times, a listing of the records to scan, and the individual request checklists. Mapping and routing of tasks are available so the field technician can schedule efficiently.

Field technicians can review their worklist 232 to determine the records they are supposed to retrieve. Field technicians will visit a facility during scheduled hours and scan records 234 for each individual for which information is to be collected. As records are scanned, they are securely transmitted to the central record repository 240. The records may be scanned and transmitted 236 in real time if a proper signal for transmission is available. If a signal is not available, the records are placed in queue and are transmitted when a signal becomes available. The field technician also completes the document checklist, indicating which documents were found and not found in the record or chart.

The records are submitted into the system either by the provider or the field technician. Providers may choose to either fax, mail, e-mail, or utilize the Internet to deliver the requested records to the system. Field technicians can scan the medical records and transmit the records to the system electronically.

Once the records are received 238, the records are loaded and held in a central record repository 240 with their associated metadata that correctly identifies the record throughout the rest of the process. In the preferred embodiment, the received records may be received or converted to .tiff format, or other electronic or digital file format, for efficient processing; however, other formats may be used. The chase is then updated to indicate readiness for triage (TRIAG/RDY) 242.

Field technicians typically scan between 3 to 5 times faster than an onsite nurse reviewer. In addition, a nurse's capacity is limited to the provider's office hours. Also, onsite nurses are required to learn all of the review types for a project as a provider may have members for every type, not just the specialty of the reviewer. Regardless of the source of submission of the records, all records are handled in the same consistent manner to assure quality and completeness.

Field technicians are trained and tested annually, similarly to the abstractors, but are trained to scan document types instead of specific record information. When at a provider office, the field technician is armed with a document checklist for each patient or member, which details the items to scan. They typically only scan documents that are relevant to the measure which makes abstraction much more efficient.

In some embodiments, records are received by mail, fax, email, or via Internet 244. Once received, the status is updated to indicate that it is in the process of scanning 246. Mailed in records go through the same process as ones that are faxed in or electronically submitted, except that the mailed record is scanned 248 to create an electronic record, such as a .tiff file. The records are uploaded into the repository 250 and the status is updated to indicate that the records are ready to undergo triage 252.

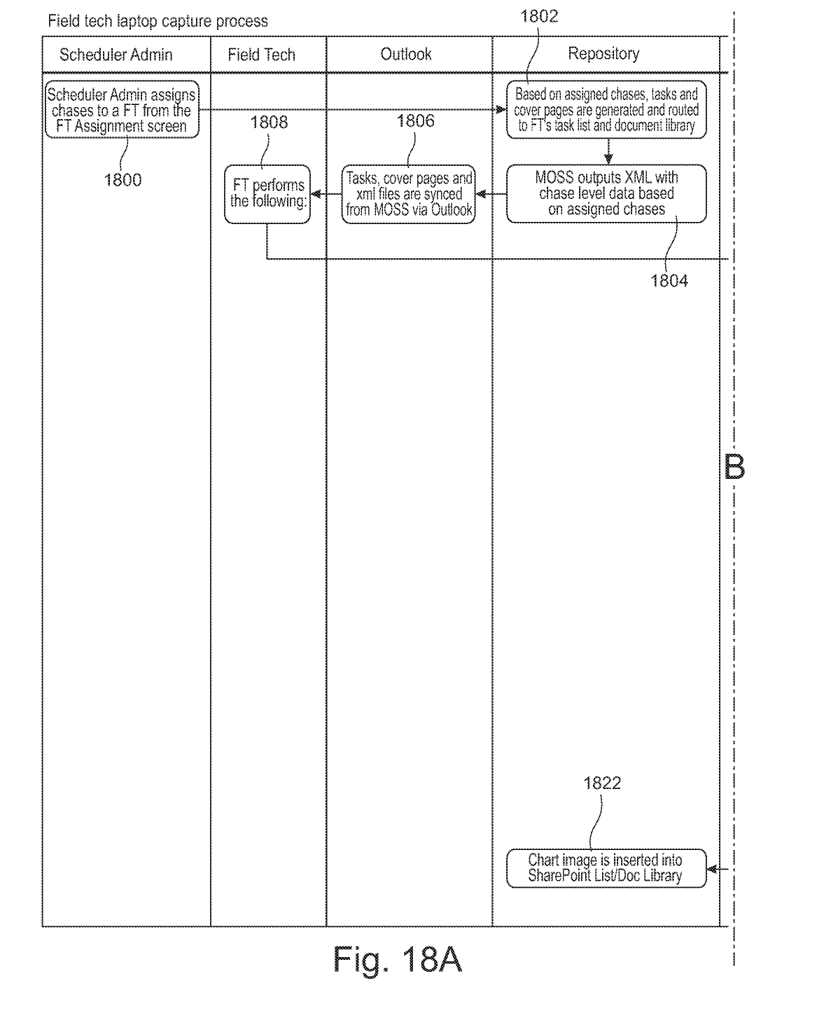

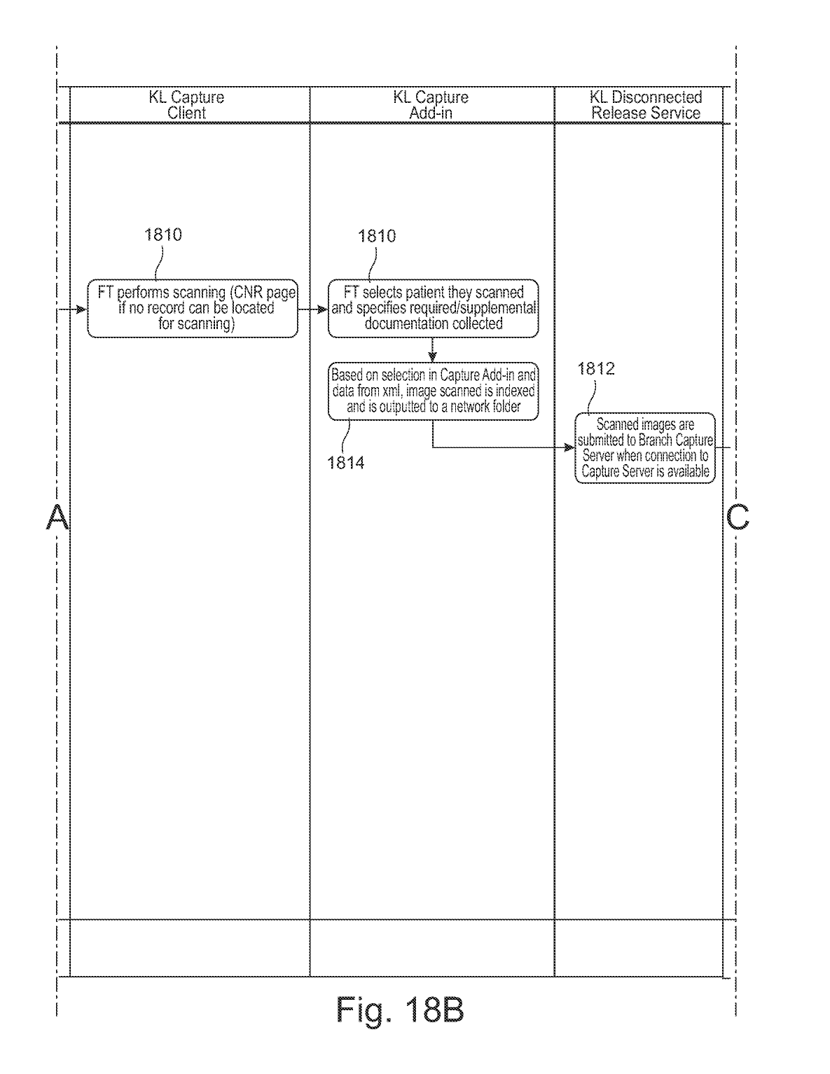

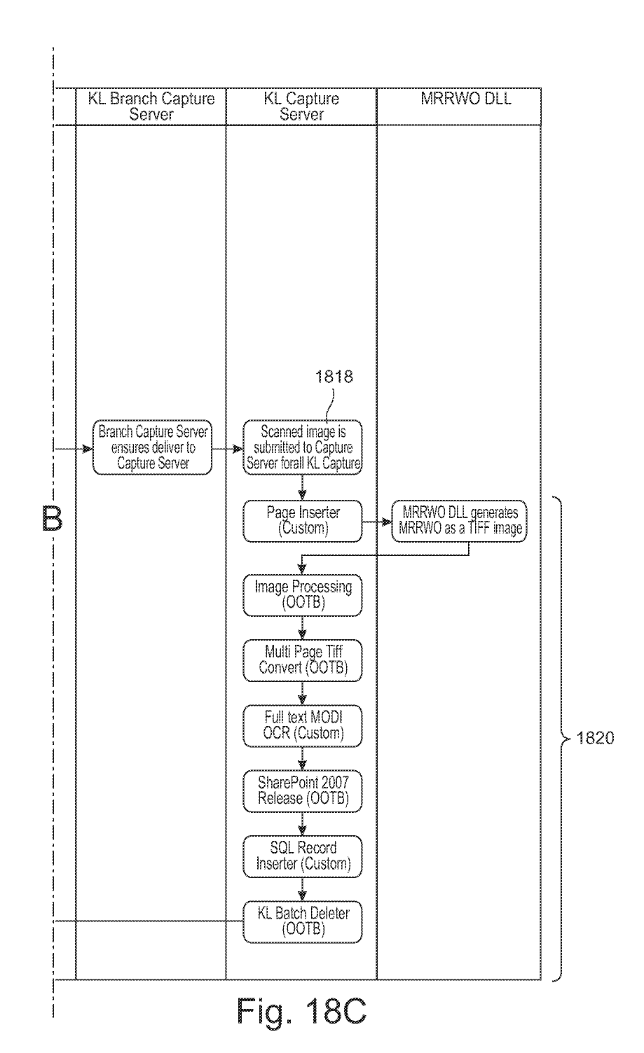

FIG. 18A-18C show an example of a process for a field technician to retrieve documents. The scheduler assigns 1800 the chase to a field technician. Based on the assigned chase, tasks and cover pages are generated 1802 and routed to the field technician's task list and document library with XML files 1804. This information may be received by the field technician via a communications software such as Outlook and synchronized 1806. The field technician can then perform the requested tasks 1808. For example, the field technician may scan 1810 the requested records. If additional or supplemental information is required the field technician can specify 1812 that as well. Any information scanned is indexed and outputted 1814 to a network folder. The scanned images may be submitted to an auxiliary server 1816 specifically designed for remote users, such as a branch Capture Server, and eventually submitted to the main server 1818. The images are processed 1820 and delivered to the repository 1822.

Triage

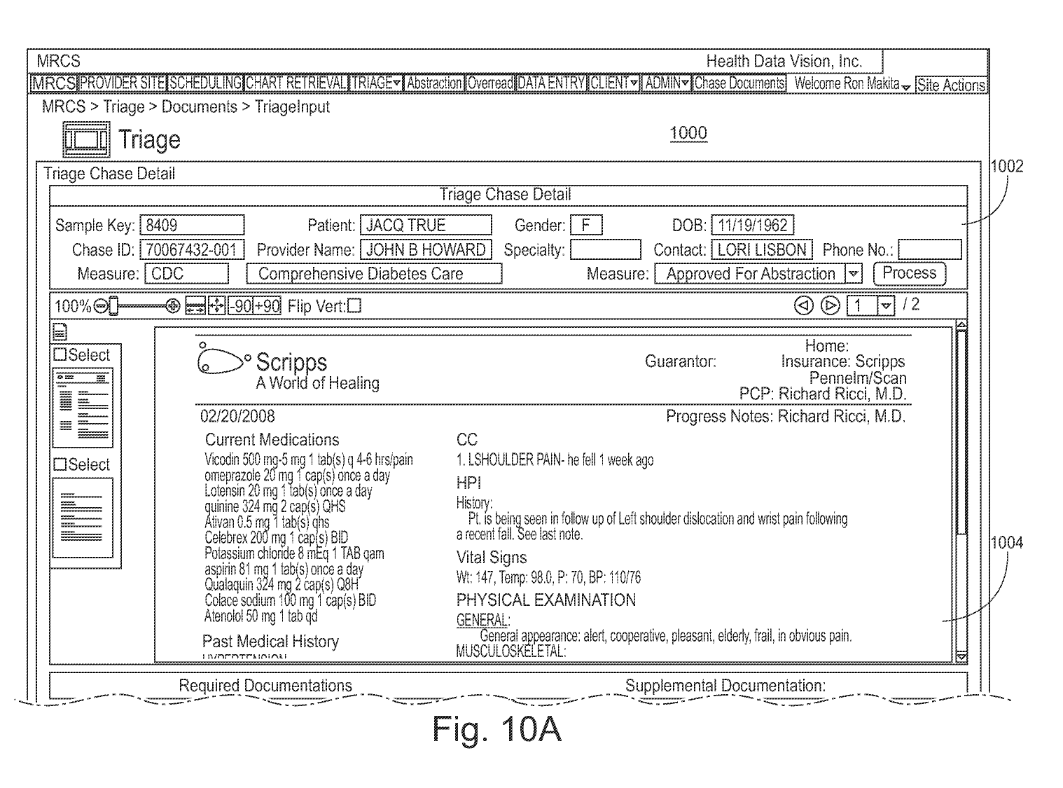

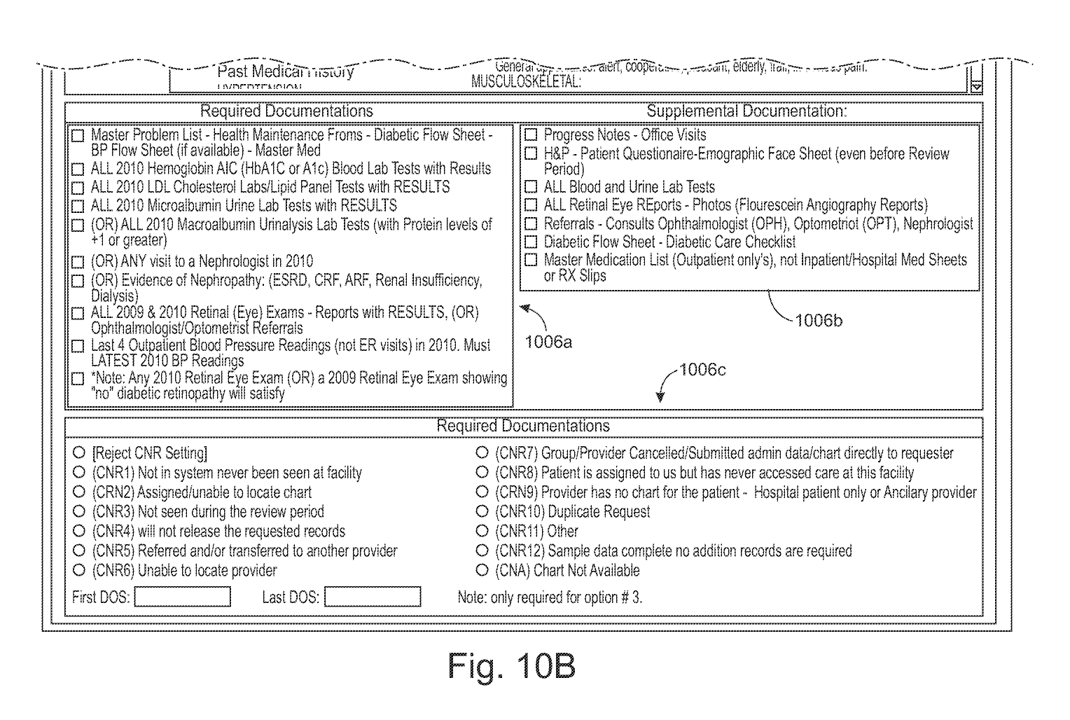

Records received by the system are quality checked, referred to as triage, by examining quality features, such as legibility, completeness, and accuracy by a triage staff member to assure the following steps have a complete chart record. Members of the team are trained to recognize document types and to check quality on each page of the documents. After the record is received into the system a team member views the worklist 254. The team member initiates the triage process 256, the status is updated to indicate that record is in the process of undergoing triage (TRIAG/INPR) 258, and the triage is performed 260. The team member opens each file, and quickly views the file to see if there are multiple members or patients in the file. If so, the file will be split so each file is assigned to the appropriate chase. The electronic checklist is filled out by a triage staff member for records that were faxed or mailed in as shown in FIGS. 10A-10B. Records submitted by the field technician are verified for accuracy by the triage staff. An electronic checklist may also be used for records submitted by field technicians. The triage staff may determine whether a chase is acceptable 262. If not, a provider may need to be re-contacted if a record is not complete or is illegible. In those cases, a notification is sent to the appropriate scheduler for secondary pursuit to retrieve the appropriate documents and the status changed to SCAN/RDY 226. In addition, incorrect or illegible pages may either be deleted or moved to the correct chase as appropriate. Thus, the triage step improves the accuracy and completeness of the record before any analysis is performed.

A sample triage chase detail 1000 is shown in FIGS. 10A and 10B displaying identifying information 1002, medical information 1004, and a checklist of documentations 1006a, 1006b, 1006c that may be required or useful.

Abstraction

Records that pass through triage are updated to indicate that they are ready for abstraction ABST/RDY 264 and made available to qualified abstractors who have access to review the records. Abstraction is the analysis conducted by the abstractor of the received records to look for the specific information requested by the client, including specific services for the patient (such as lab tests, prescriptions, screening tests, etc.) or all services provided. Abstractors have a wide range of qualifications and backgrounds, and include registered nurses (RN), licensed vocational nurses (LVN), licensed practical nurses (LPN), certified coders, registered health information administrators (RHIA), registered health information technicians (RHIT), and the like.

The system allows abstractors to be completely location and work-hour independent, thereby avoiding visits during provider office hours, navigating through traffic, parking, or other field logistics. Abstractors can work in a virtual office; specifically, they can work from home at any time, accessing the system through, for example, a secure browser over the Internet. Abstractors can be nationwide, and the system allows them to be assigned to projects based on their skills and expertise rather than their physical location.

Abstractors are grouped into teams that specialize only in certain measures depending on their specific backgrounds and testing results. They are assigned batches of records by measure rather than by provider. This has proven to be extremely efficient, as the abstractor can focus on a single measure, and does not have to know all of the measures.

The abstractor utilizes an abstraction viewer application to view the files and conduct the analysis. The abstractor receives the worklist 266 or 274 and initiates abstraction for the chase 268 or 276. The status is updated to indicate that the chase is ready for abstraction (ABST/RDY) 270 or 278 and the abstraction is performed 272 or 280. The abstraction viewer displays the chart and abstraction tool side by side, and entries automatically calculate and display measure compliance at both the sub-measure and full measure level. Each chase for a member is also abstracted separately and the results aggregated so there is no confusion on the services provided by each provider. If a member has multiple chases, the abstractor may view the charts and the separate abstraction results for the member. When entering review results, the page number of chart is automatically recorded. This is particularly helpful to administrators and clients that may review the results for quality. Additional meta-data, including a digital version (with optical character recognition) of the medical record may be used.

In addition to searching for services within a chart, if an abstractor finds a “clue” within the chart that indicates that the record is not complete for a required service, the abstractor has the option of putting the chase into a secondary pursuit. For example, a record may contain a notation indicating that other tests have been conducted at a different facility. A secondary pursuit is a process that sends a notification back to the scheduling team to either go back to the original provider, or to a different provider to further investigate whether other records exist. Secondary pursuit maximizes results by creating a complete file for analysis rather than ignoring or not recognizing that a file may not be complete or accurate.

In some instances, a record may be incomplete or inaccurate due to the non-compliance of the member or patient. Abstractors are required to select a reason code indicating the reason for non-compliance. Examples of reason codes include “Physician ordered test, but patient non-compliant”, “Test given but outside of timeframe”, “Test level out of range.” Reason codes are important, especially in post-project review and analysis.

Overread

Overread is conducted throughout the project to assure quality rather than at select points in time, such as a few records at the beginning of the process, which could lead to errors downstream of the process. The overread process checks the quality of the analysis or abstraction conducted by the abstractors to assure accuracy and completeness, i.e. quality assurance.

Abstractor's records may be overread 282 for quality by a senior abstraction staff member. If overread is desired, the status is updated to indicate that the chase is ready for overread (OVER/RDY) 284; otherwise, the status is updated to indicate that the chase is ready for data entry (ENTRY/RDY) 296. If overread is desired, the overreader views the worklist 286, initiates the overread process 288, and updates the status to indicate that the chase is in the process of being overread (OVER/INPR) 292. The overread scores may be displayed and calculated in real time, which identifies quality issues immediately and reduces any delay in taking corrective action.

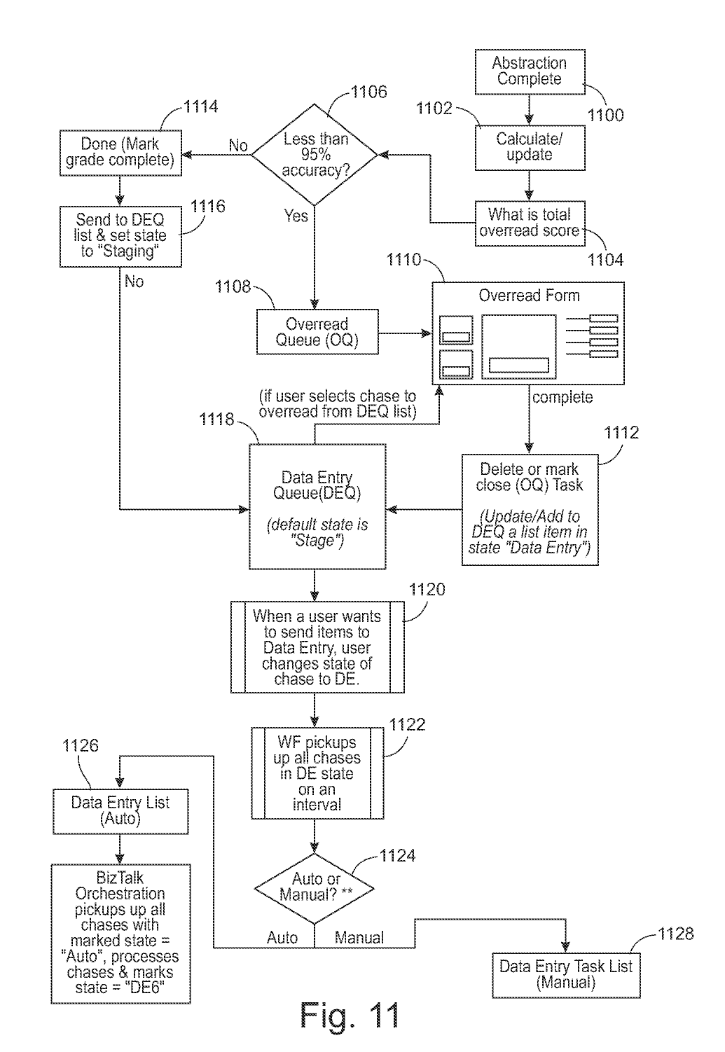

An example of the overread process is shown in FIG. 11. Abstractors start off at 100% or a score of 100. Once the abstraction is complete 1100 a report card is updated 1102 to the chase with a total overread score 1104. A determination is made whether the abstractor met his or her standard 1106. Any abstractor that falls below an established accuracy standard is flagged and corrective action is taken. The percentage of overread is set in the project configuration and varies by project and client. For example, abstractors are expected to meet a 95% accuracy standard. Any abstractor that falls below the accuracy standard may be re-trained to assure there is a correct understanding of the measure and the overread percentage is increased until the standard is achieved. An abstractor will be removed from the team if not abstracting at the predetermined standard.

Chases from abstractor who do not meet the established standard are added to an overread queue 1108 and overread again 1110. Once complete 1112, the chase enters the data entry queue 1118. If the chase meets the established standard it is marked as done 1114 and marked to send 1116 to the data entry queue (DEQ) 1118. The status of the chase is updated indicate that it is to be sent to data entry (DE) 1120. All chases designated as DE are picked up 1122 and a determination 1124 is made whether the data entry is conducted automatically 1126 or manually 1128.

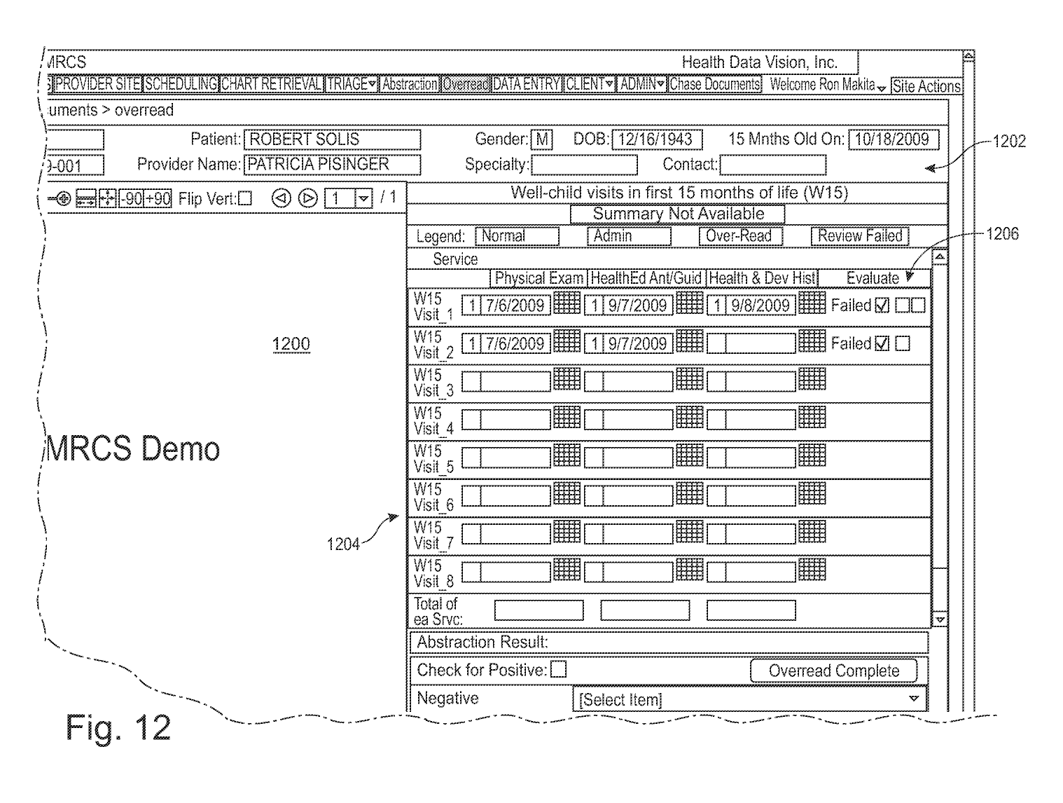

A partial sample overread form 1200 is shown in FIG. 12 displaying the patient's information 1202, the service information 1204, and the results of the overread 1206 for each service provided.

Client Review/Client Portal

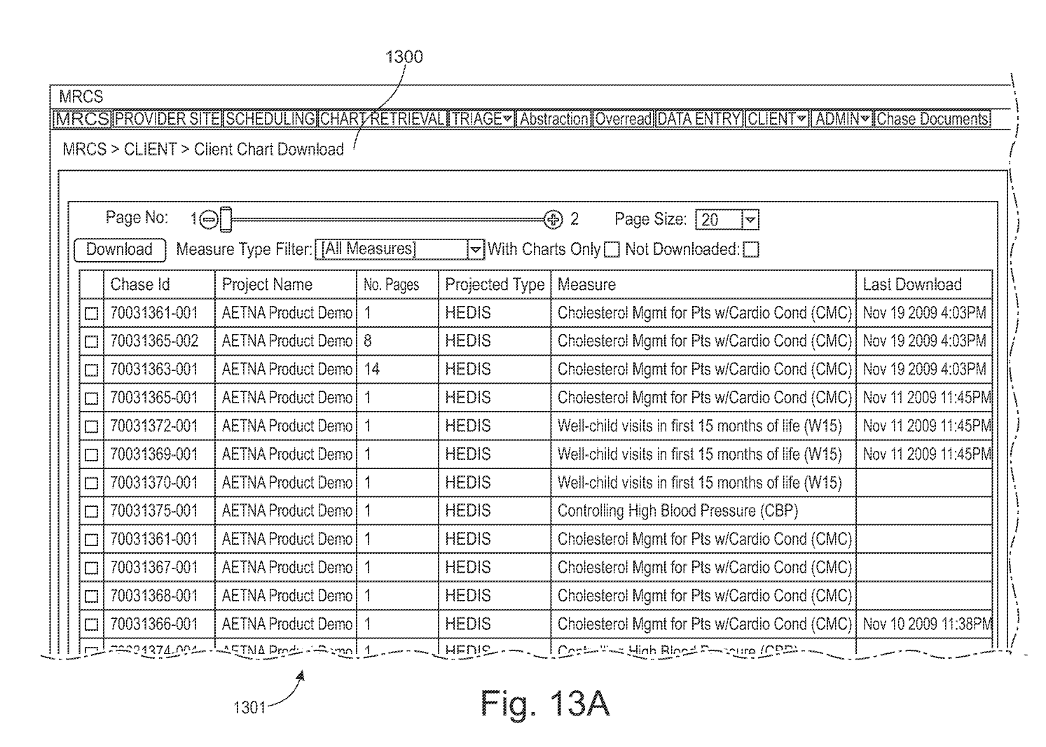

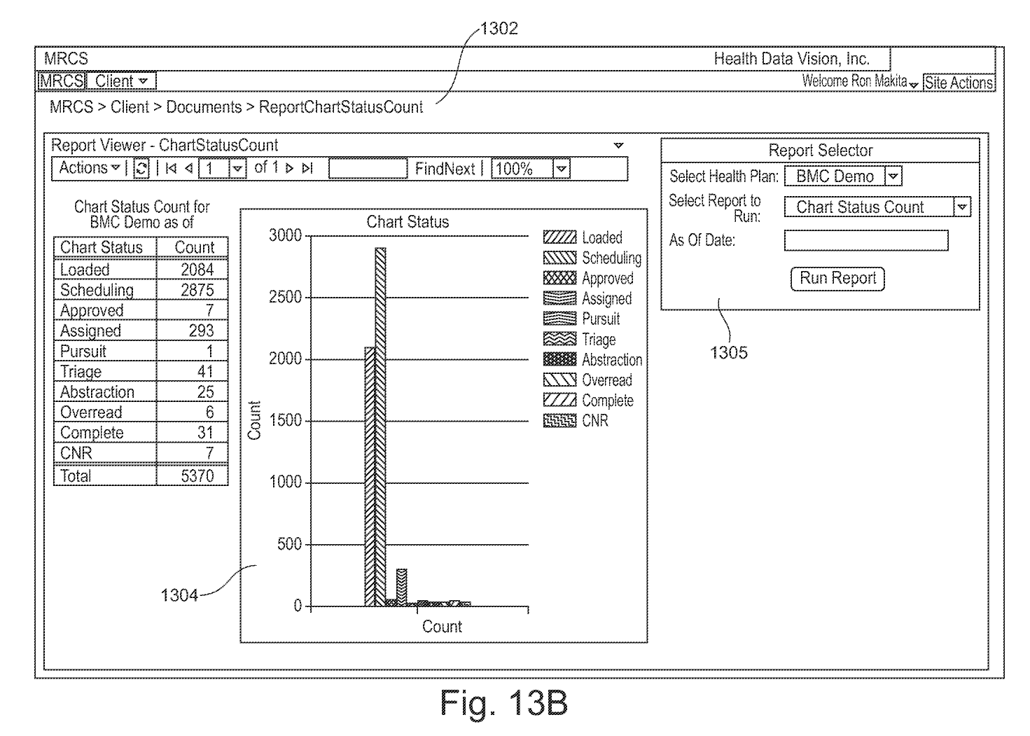

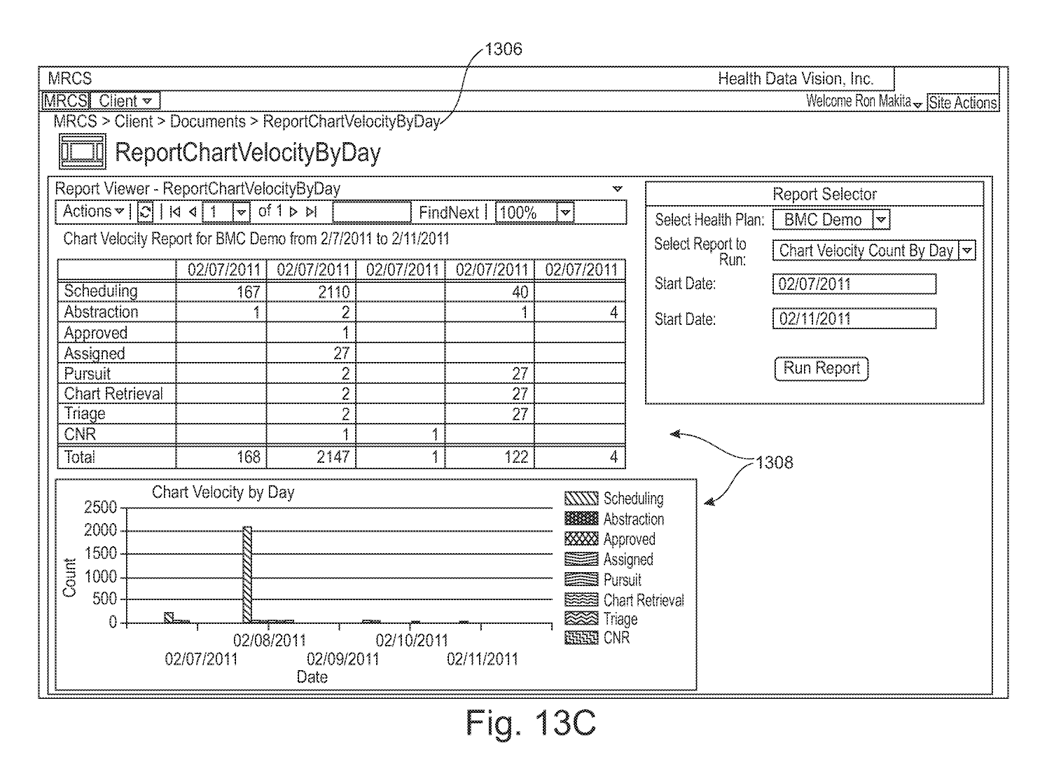

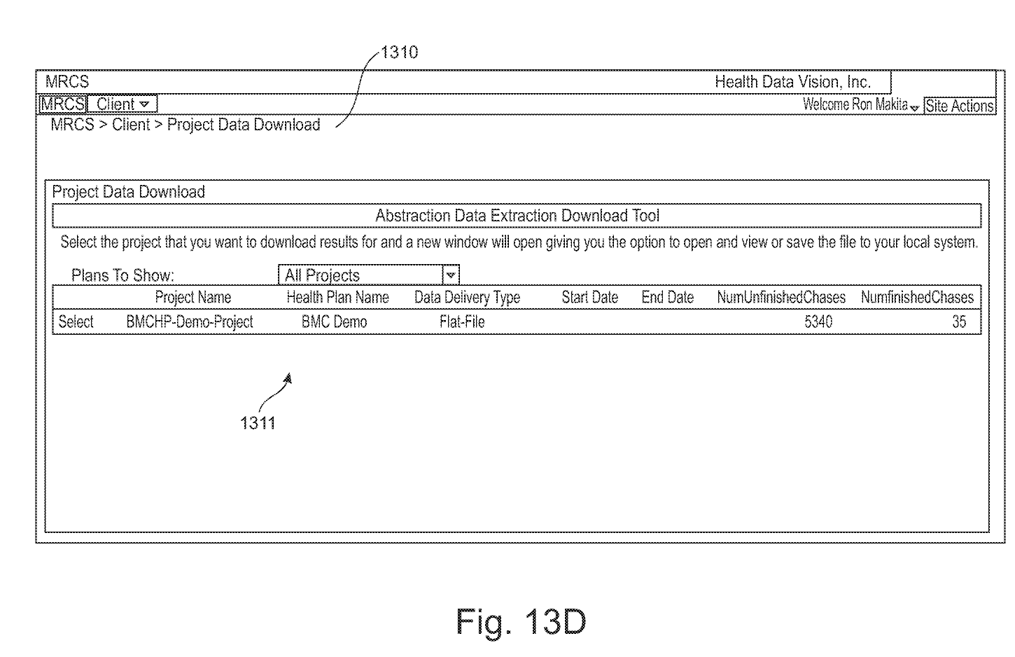

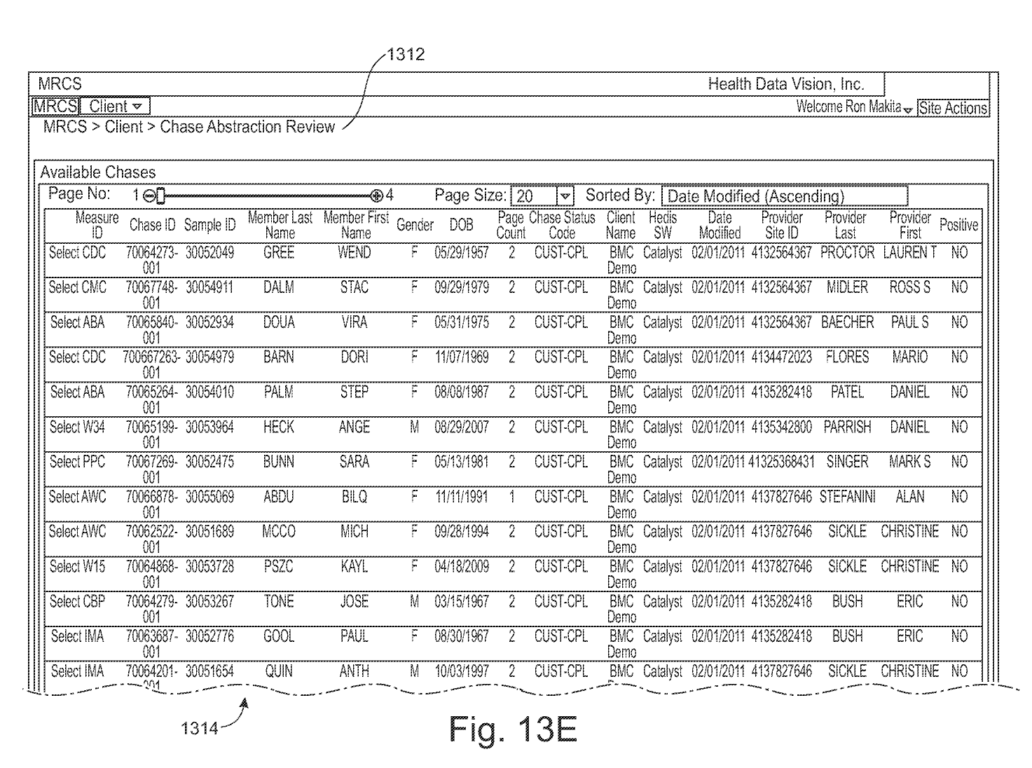

Clients can use the client portal section of the system to monitor and review their requests. For example, as shown in FIG. 13A, client chart download feature 1300 allows clients to locate and download charts 1301 in a .zip file for further use or analysis. This is typically necessary to pull sample charts and analysis for auditors. This ‘on demand’ feature makes this process extremely easy and efficient. In a specific example, all charts that have passed through overread may be available for client to review or download. If desired, client may view the abstraction results for accuracy of abstraction and provide feedback to the lead abstractor.

As shown in FIG. 13B, a chart status report feature 1302 shows in real-time the status 1304 of the different chases in a sequential fashion, allowing clients to keep up to date on the project progress. Drill-down capabilities 1305 allow viewing of different sub-groupings of the information (e.g. by analysis type) all the way down to the individual instance level. This is made possible because of the way the system breaks down and tracks all the events in the process. In addition, the type of reporting and the near-real time refresh of report data enable the real-time nature of the report.

As shown in FIG. 13C, a velocity report feature 1306 shows the actual activity 1308 on a daily basis, i.e. what tasks have been performed in each stage of the process. Again, drill-down capabilities allow more granular analysis. This report also updates in real-time for the current day in the report. This detailed analysis allows clients and the system to precisely manage the pace of the project, identify any bottlenecks and other irregularities, hence providing a new tool to effectively and predictably manage these types of projects.

As shown in FIG. 13D, a project data download feature 1310 allows the client to download any analysis information 1311 in the client portal in the specified format (see project configuration), for further analysis or for import into another system whenever the client pleases.

As shown in FIG. 13E, a client abstraction review feature 1312 allows clients to perform their own check on the abstraction work done 1314 in the process. This feature is used to perform a client's own quality checking on the work done in the system and provide feedback to the project team.

Clients may have 24 hour access to real time project status reports. Every provider, chase, and chart status is tracked in detail and reporting may be available on the overall status, specific measure status, trend to completion, and drill-down capability to a provider or the actual chart itself.

Delivery of Results

The system may consolidate the abstracted data and deliver a flat file at scheduled intervals in real time or on demand. The system may contain mapping configurations and data transport methods with each client to assure proper format and file transfer.

Computer System

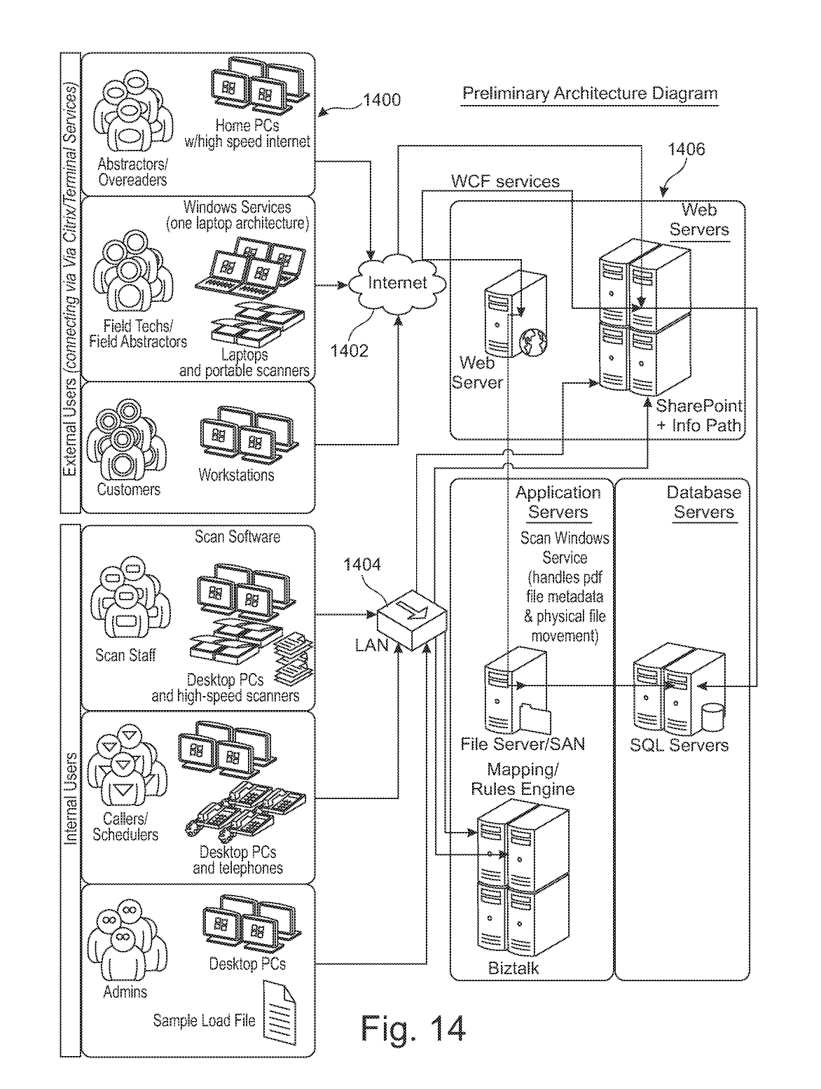

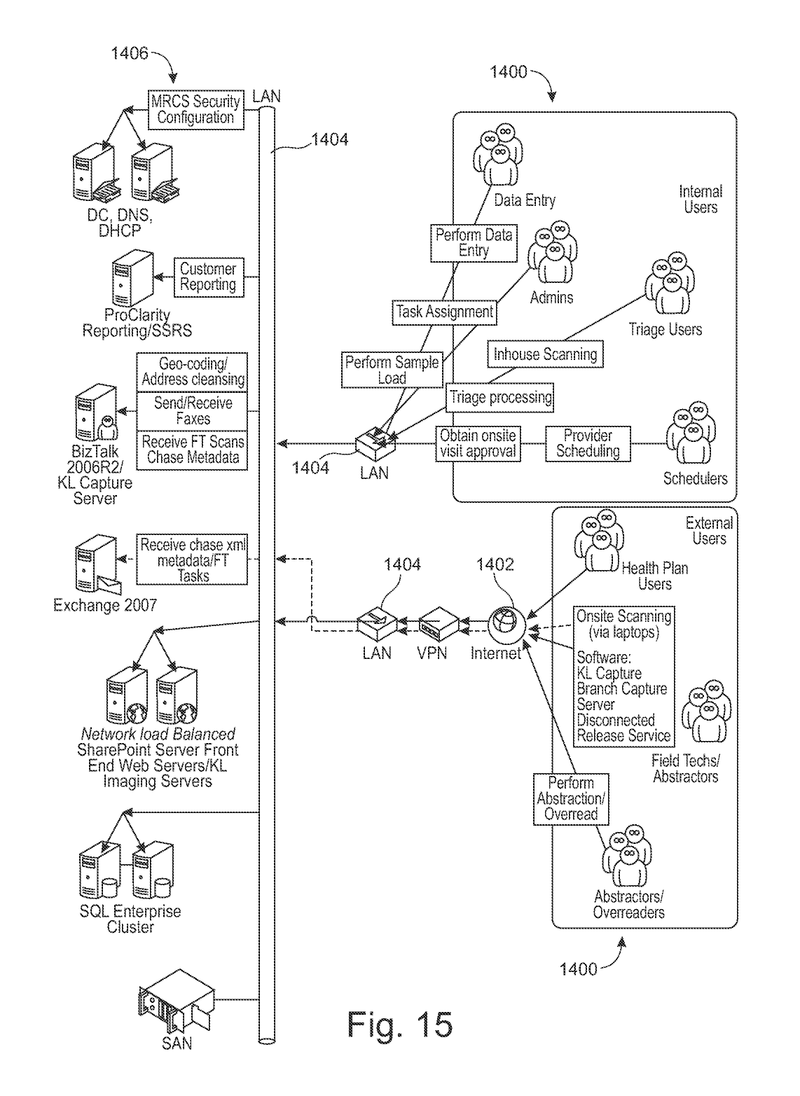

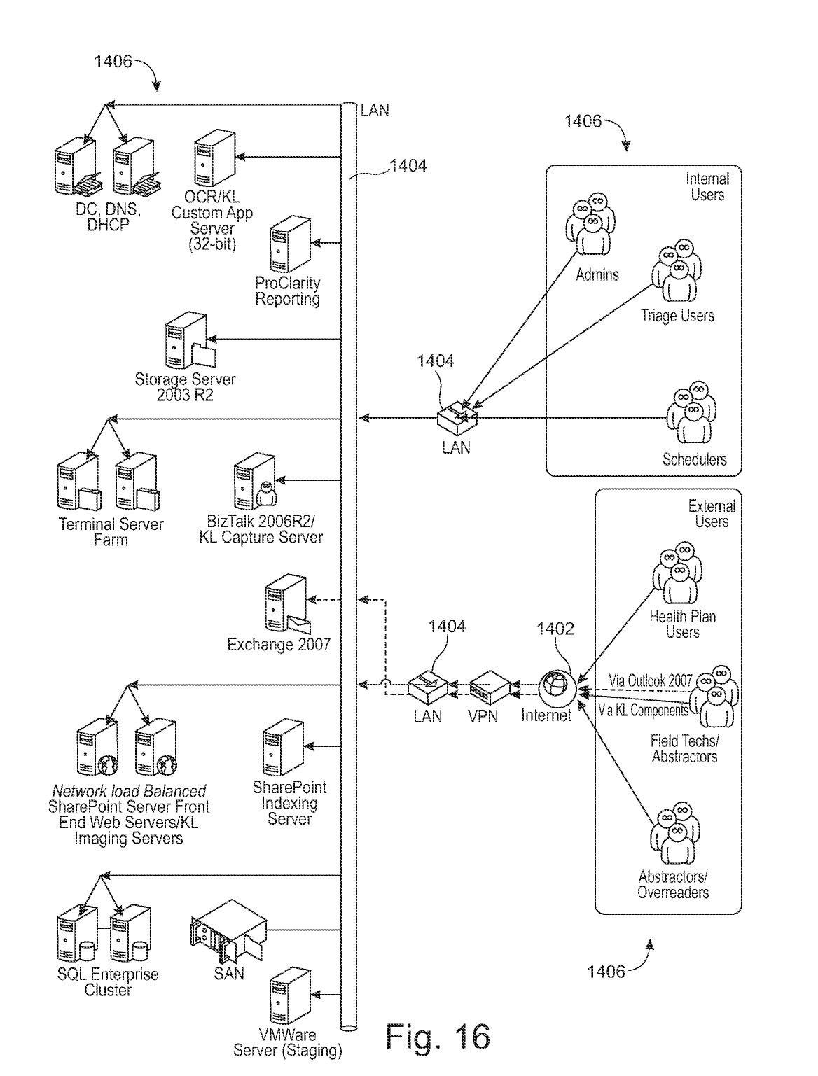

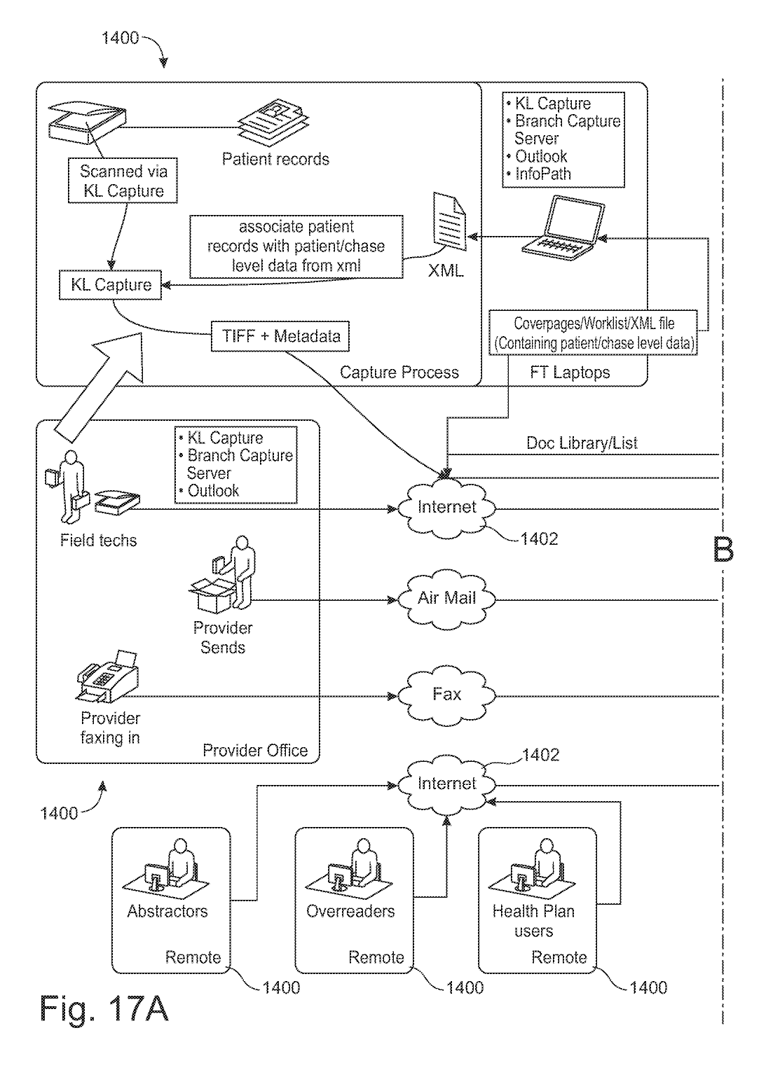

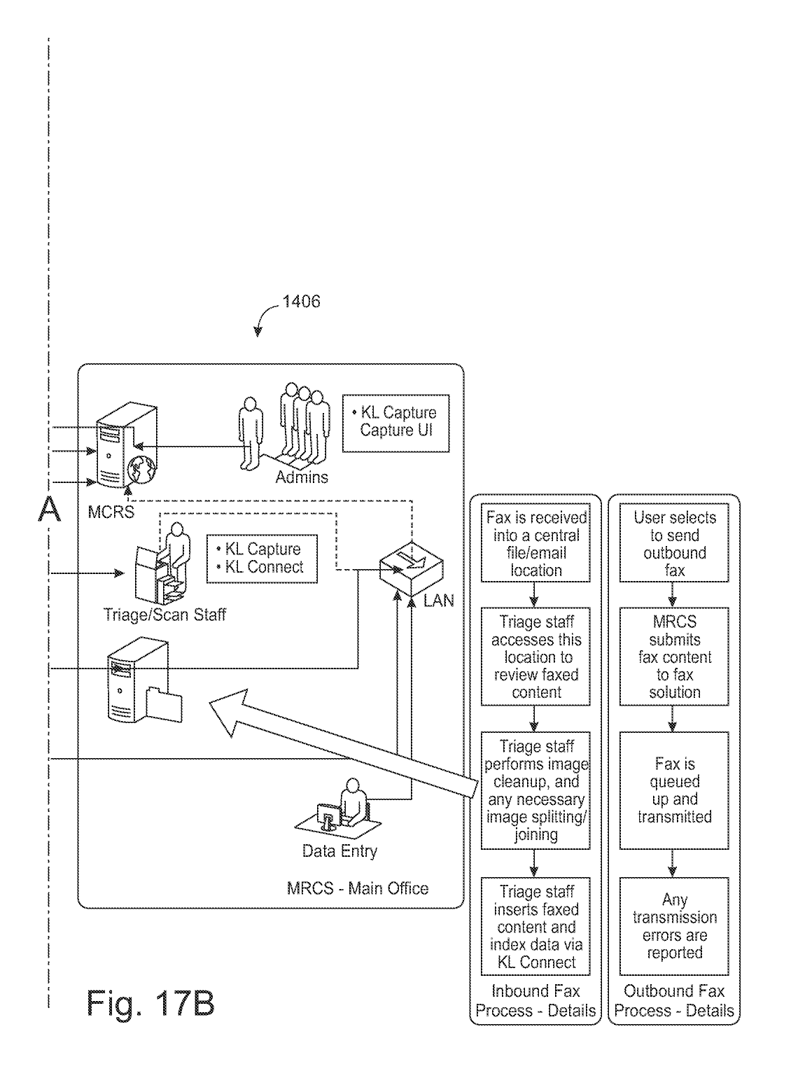

FIGS. 14-18C show examples of the architecture to implement the system. These are provided as examples only and are not intended to be limited to these specific examples. In some embodiments, the web-based front-end of the system runs on Microsoft SharePoint Server, using its Microsoft SQL-Server based document repository on the backend as well as other features and custom code. The loading of data, exchanging of inbound and outbound fax messages runs through Microsoft BizTalk Server, which integrates with external services for address cleansing, geo-coding, fax delivery and receiving as well as Microsoft BingMaps for mapping in the scheduling and field-tech assignment functions of the solution.

Security of the system is handled through a modern, firewall setup. The firewall solutions used Microsoft ISA Server and secure traffic is ensured via HTTPS, with a security certificate issued by a trusted security authority.

The portal is structured into different ‘sites’, each of which serves a specific function in the process.

The field technician laptops use a secure HTTPS connection to link up with the central system to download itineraries and to upload scanned charts to the central system. The laptops are secured and locked down (files cannot be copied, printed, or emailed externally, only uploaded to the repository), full-volume encryption ensures that data cannot be compromised). Microsoft Outlook may be used to synchronize itinerary items as tasks. Data from the tasks is passed to MS MapPoint and to KnowledgeLake (KL) Capture client, the scanning client software. This ensures that there is no mis-typing of patient names or other information. A valid selection needs to be made for a medical chart to be associated, eliminating orphan records and mis-associations, both major problems in the industry.

Small, portable and fast scanners are used to scan records on site at provider offices.

The system can take the form of a computer program product, such as a computer-usable or computer-readable medium providing program code for use by or in connection with a computer. For the purposes of this description, a computer-usable or computer readable medium can be any apparatus that can contain, store, communicate, propagate, or transport the program for use by or in connection with the instruction execution system, apparatus, or device.

The medium can be an apparatus or device that utilizes or implements an electronic, magnetic, optical, electromagnetic, infrared, semiconductor system, or propagation medium. Examples of a computer-readable medium include, but are not limited to, a semiconductor or solid-state memory, magnetic tape, a removable computer diskette, a random access memory (RAM), a read-only memory (ROM), a rigid magnetic disk and an optical disk. Current examples of optical disks comprise compact disk-read only memory (CD-ROM), compact disk-read/write (CD-R/W) and DVD.

A data processing system suitable for storing and/or executing program code comprises at least one processor coupled directly or indirectly to memory elements through a system bus. The memory elements can include local memory employed during actual execution of the program code, bulk storage, and cache memories that provide temporary storage of at least some program code in order to reduce the number of times code is retrieved from bulk storage during execution.

Input/output or I/O devices 1400 (including input-only and output only device, such as, but not limited to keyboards, displays, pointing devices, disk drives etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Described above, aspects of the present system can utilize the World Wide Web (“WWW”) or (“Web”) site accessible via the Internet 1402. As is well known to those skilled in the art, the term “Internet” refers to the collection of networks and routers that use the Transmission Control Protocol/Internet Protocol (“TCP/IP”) to communicate with one another. The internet can include a plurality of local area networks (“LANs”) 1404 and a wide area network (“WAN”) that are interconnected by routers. The routers are special purpose computers used to interface one LAN or WAN to another. Communication links within the LANs may be wireless, twisted wire pair, coaxial cable, or optical fiber, while communication links between networks may utilize analog telephone lines, digital T-1 lines, T-3 lines or other communications links known to those skilled in the art.

Furthermore, computers and other related electronic devices can be remotely connected to either the LANs or the WAN via a digital communications device, modem and temporary telephone, or a wireless link. It will be appreciated that the internet comprises a vast number of such interconnected networks, computers, and routers.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HTML, or other markup languages, that are electronically stored at or dynamically generated by “WWW sites” or “Web sites” throughout the Internet. Additionally, client-side software programs that communicate over the Web using the TCP/IP protocol are part of the WWW, such as JAVA® applets, instant messaging, e-mail, browser plug-ins, Macromedia Flash, chat and others. Other interactive hypertext environments may include proprietary environments such as those provided by online service providers, as well as the “wireless Web” provided by various wireless networking providers, especially those in the cellular phone industry. It will be appreciated that the present application could apply in any such interactive communication environments, however, for purposes of discussion, the Web is used as an exemplary interactive hypertext environment with regard to the present application.

A website is a server/computer 1406 connected to the Internet that has massive storage capabilities for storing hypertext documents and that runs administrative software for handling requests for those stored hypertext documents as well as dynamically generating hypertext documents. Embedded within a hypertext document are a number of hyperlinks, i.e., highlighted portions of text which link the document to another hypertext document possibly stored at a website elsewhere on the Internet. Each hyperlink is assigned a URL that provides the name of the linked document on a server connected to the Internet. Thus, whenever a hypertext document is retrieved from any web server, the document is considered retrieved from the World Wide Web. Known to those skilled in the art, a web server may also include facilities for storing and transmitting application programs for execution on a remote computer. Likewise, a web server may also include facilities for executing scripts and other application programs on the web server itself.

A remote access user may retrieve hypertext documents from the World Wide Web via a web browser program. Upon request from the remote access user via the web browser, the web browser requests the desired hypertext document from the appropriate web server using the URL for the document and the hypertext transport protocol (“HTTP”). HTTP is a higher-level protocol than TCP/IP and is designed specifically for the requirements of the WWW. HTTP runs on top of TCP/IP to transfer hypertext documents and user-supplied form data between server and client computers. The WWW browser may also retrieve programs from the web server, such as JAVA applets, for execution on the client computer. Finally, the WWW browser may include optional software components, called plug-ins, that run specialized functionality within the browser.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A computer-implemented method for processing a medical record that allows a client to configure its own project, comprising:
a. collecting, standardizing and mapping a provider's information, wherein mapping a provider's information comprises geo-coding the provider's location;
b. receiving a request for a medical record of a patient from a client;
c. utilizing a scheduling system for requesting and retrieving records from the provider;
d. providing an option of using field technicians;
e. inputting the retrieved medical record into a database;
f. utilizing a triage system to check for quality of the records retrieved, wherein the quality is determined by examining a quality factor selected from the group consisting of a legibility, completeness, and accuracy;
g. providing analysis by qualified staff members through an abstraction analysis of the record;
h. maintaining accuracy of the abstraction through an overread process, wherein the overread process is conducted throughout the method for processing the medical record;
i. delivering a result that can be reviewed by and delivered to the client according to the client's specification; and
j. providing a configurable system for the client to input desired specifications to omit or modify any of the steps above.

2. The method of claim 1, wherein the mapping of a provider's information is displayed on a display device.

3. The method of claim 1, wherein the retrieved records are electronically tagged to identify a status of the retrieved record during processing.

4. The method of claim 1, wherein the medical record is converted to an electronic file for electronic processing.

5. A method of processing medical records, comprising:
a. a system receiving a request from a client for information of an individual from whom information is desired;
b. retrieving the information by having a scheduler contact a health care provider of the individual, organize the proper paperwork, and either have the health care provider send the information back to the system, or arrange a time for onsite copying and dispatching a field technician to retrieve the medical record;
c. inputting the retrieved medical record into a database;
d. having a triage staff conduct a quality check of the retrieved information for proper form and content;
e. having the retrieved information sent to a reviewer to analyze the retrieved information and report on whether the information meets a predetermined standard; and
f. having the information entered on an online form where the client can access the information.

6. The method of claim 5, further comprising scrubbing to standardize and enrich address formats of health care providers.

7. The method of claim 5, further comprising grouping and mapping provider sites to allow for efficient dispatch of field technicians to retrieve information.

8. The method of claim 5, further comprising using patient record metadata for efficient processing.

9. The method of claim 5, further comprising making electronic patient checklists for records collections.

10. The method of claim 5, wherein inputting the retrieved information into a database comprises secure wireless transmission of the information in real-time.

11. The method of claim 5, further comprising establishing an efficient record review tool by providing exception handling processes for incomplete and missing records.

12. The method of claim 5, further comprising conducting a quality check on the analyzed retrieved medical record.

13. The method of claim 5, further comprising sending the information to the client.

14. A non-transitory computer readable medium storing instructions for causing at least one processor to perform a method that allows a user to configure its own project for processing a medical record, the method comprising:
a. collecting, standardizing and mapping a provider's information;
b. utilizing a scheduling system for requesting and retrieving records from the provider;
c. providing an option of using field technicians;
d. providing a triage system to check for quality of the records retrieved;
e. providing an abstraction process to allow a staff member to conduct an analysis of the record;
f. providing an overread process to allow quality control and correction of the abstraction;
g. delivering a result that can be reviewed by the client according to the client's specification; and
h. providing a configurable system for the client to input desired specifications to omit or modify any of the steps above.

15. The method of claim 14, wherein mapping a provider's information comprises geo-coding the provider's location and displaying the geo-coded provider's information on a display device.

16. The method of claim 14, further comprising providing for a secondary pursuit to allow for further investigation in the event the medical record is determined to be incomplete.

17. The method of claim 14, wherein the quality is determined by examining a quality factor selected from the group consisting of legibility, completeness, and accuracy.

18. The method of claim 14, wherein the overread process is conducted throughout the method for processing the medical record.
